(19) United States
(12) Patent Application Publication
(10) Pub. No.: US 2012/0235531 A1
(43) Pub. Date: Sep. 20, 2012

(54) MOTOR-DRIVEN COMPRESSOR

(75) Inventors: Hiroshi Fukasaku, Aichi-ken (JP); Minoru Mera, Aichi-ken (JP)

(73) Assignee: KABUSHIKI KAISHA TOYOTA JIDOSHOKKI, Kariya-shi (JP)

(21) Appl. No.: 13/419,498

(22) Filed: Mar. 14, 2012

(30) Foreign Application Priority Data
Mar. 18, 2011 (JP) 2011-061275
Dec. 2, 2011 (JP) 2011-264627

(51) Int. Cl. H02K 1/27

(52) U.S. Cl. 310/156.23

(57) ABSTRACT

A compressor includes a housing, a compression mechanism and an electric motor driving the compression mechanism. The electric motor includes a stator fixed to the housing, a rotary shaft rotatably supported by the housing, a rotor that is fixed on the rotary shaft and has a rotor core made of a plurality of laminated steel sheets, a magnet insertion hole formed through the rotor core, a permanent magnet loosely fitted in the magnet insertion hole, a first clearance formed between inner surface of the magnet insertion hole and outer surface of the permanent magnet, a second clearance formed between end surface of the rotor core and surface of the permanent magnet in the axial direction of the rotor core and resin filled in the first clearance and the second clearance so as to surround entire surface of the permanent magnet.

### BACKGROUND OF THE INVENTION

The present invention relates to a permanent magnet embedded type motor-driven compressor.

A motor-driven compressor having an electric motor housed in a housing of the compressor can serve as a drive source of a compression mechanism of a vehicle air conditioner. The electric motor that is known as a permanent magnet embedded electric motor includes a stator wound with a coil and a rotor having a rotor core in which a permanent magnet is embedded. The motor-driven compressor is configured so that refrigerant gas containing lubricating oil and a small amount of water flows from surroundings of the electric motor to the compression mechanism. The refrigerant for use in a vehicle air conditioner contains water in no small amount. The conduit used for the air conditioner is made of a flexible material such as a rubber tube that is hardly adversely affected by flexion of the tube and vibration of the vehicle, so that the vehicle air conditioner is suitably installed in a small and complicated space accommodating many other components of the car. Therefore, some water permeates through the conduit into a refrigerant circuit of the vehicle conditioner.

When the temperature of the lubricating oil in the motor-driven compressor becomes high during the operation of the vehicle air conditioner, water in the refrigerant circuit is diffused in the lubricating oil, so that any trouble associated with the water rarely occurs. However, when the temperature of the lubricating oil is decreased, e.g. due to a stop of the motor-driven compressor, the amount of saturated water vapor in the lubricating oil is decreased, so that a normegligible amount of free water is produced. Such free water remains in a clearance of a magnet insertion hole formed in the rotor core of the electric motor, thereby corroding the permanent magnet and hence deteriorating the performance of the electric motor and the cooling performance of the vehicle air conditioner. The corrosion of the permanent magnet by free water is remarkable under a hot and humid environment.

Japanese Patent Application Publication 2009-225636 discloses a motor-driven compressor of a vehicle air conditioner having an electric motor that is configured so as to prevent the permanent magnet from being corroded by a corroding substance generated by the dissolution of refrigerant gas. The permanent magnet is covered with a coating layer made of a nonmagnetic metal and inserted in a magnet insertion hole formed in a rotor core of the electric motor. Although the coating layer of the permanent magnet is exposed to refrigerant gas, the permanent magnet is not subjected to the influence of refrigerant gas directly, so that the permanent magnet is protected against the corroding substance generated by the dissolution of refrigerant gas.

Japanese Patent Application Publication H09-163649 discloses a permanent magnet embedded type motor that prevents a permanent magnet of the motor from being broken when the permanent magnet is inserted into a magnet insertion hole of a rotor core of the motor. The magnet insertion hole is formed large enough to receive therein the permanent magnet wrapped by adhesive sheet that is impregnated or coated with adhesive. The adhesive sheet is made of a glass fiber and the adhesive is of an epoxy type resin having good adhesion and chemical resistance. The permanent magnet being inserted into the magnet insertion hole of the rotor core is free from direct contact with the rotor core because of the adhesive sheet covering the permanent magnet, so that the permanent magnet is prevented from breakage and surface delamination. For example, when neodymium sintered magnet is used as the permanent magnet, development of corrosion of the permanent magnet due to any breakage is prevented. The permanent magnet may be fixed firmly to the magnet insertion hole of the rotor core by hardening the glue coated on the sheet after the permanent magnet is set in a predetermined position in the magnet insertion hole.

Japanese Patent Application Publication S59-18852 discloses a technology related to an electric motor used for driving a timepiece. The rotor of the motor includes a rotor shaft having a circular cross-section and made of a nonmagnetic material, and an annular rotor magnet press-fitted on the rotor shaft. When the rotor magnet is press-fitted, the rotor shaft and the magnet may grind each other thereby to produce metal and magnet particles. There is a fear that such particles may enter into a bearing of the rotor, thereby adversely affecting the rotation of the rotor and finally causing the motor to be stopped. The rotor of the above Publication further includes a rotor shaft, a single-piece cylindrical holder made of a highly elastic nonmagnetic cylindrical member and a pinion both of which are fitted on the rotor shaft. The magnet holder is engaged with the rotor shaft in a manner that keys formed in the hole of the magnet holder are engaged with a keyway formed in the rotor shaft so that the magnet holder and the pinion are rotated together with the rotor shaft. The rotor magnet mounted loosely on the rotor shaft is fitted in the magnet holder in such a way that the outer peripheral surface of the rotor magnet is in contact with inner surface of the magnet holder, the bottom of the rotor magnet is in contact with the inner bottom surface of the magnet holder and also that the top of the rotor magnet is positioned below the top opening of the magnet holder. Adhesive is filled in a space formed between the top of the opening of the magnet holder and the top of the rotor magnet. In this case, the adhesive is flowed into a small clearance between the rotor shaft and the rotor magnet and enhances the adhesion strength therebetween.

The motor-driven compressor of the Japanese Patent Application Publication 2009-225636 has a problem in that formation of pinholes in the coating layer of the permanent magnet during the manufacturing process is inevitable and also that the coating layer may be scratched when the permanent magnet is press-fitted into the magnet insertion hole. Such pinholes and the scratched surface of the coating layer allow lubricating oil to flow therethrough to the permanent magnet and to attach to the permanent magnet, and free water produced from the lubricating oil corrodes the permanent magnet. Particularly, in the rotor core of the electric motor that is made of laminated magnetic steel sheets, the free water may permeate through small clearances between the laminated magnetic steel sheets into the magnet insertion holes and attached to the permanent magnet, with the result that the free water corrodes the permanent magnet.

In the electric motor of the Japanese Patent Application Publication H09-163649, the permanent magnet has no adhesive sheet at the opposite ends thereof and, therefore, the problem of the corrosion of the permanent magnet by the free water cannot be resolved. When the permanent magnet covered with the adhesive sheet is press-fitted into the magnet insertion hole of the rotor core, the permanent magnet may not be damaged because of the protection by the adhesive sheet, but the adhesive sheet may be scratched, so that lubricating oil permeates through the scratched surface of the adhesive sheet and is attached to the permanent magnet. Thus, the corrosion of the permanent magnet by the free water can not be prevented. Additionally, the rotor core that is made of laminated magnetic steel sheets allows lubricating oil to permeate through small clearances between the laminated magnetic steel sheets and the scratched surface of the adhesive sheet and to be attached to the permanent magnet, as in the case of the motor-driven compressor of the Japanese Patent Application Publication 2009-225636, with the result that free water produced from the lubricating oil may corrode the permanent magnet.

In the clock driving motor of the Japanese Patent Application Publication S59-18852, the rotor magnet is supported and held by a magnet holder so that the rotor magnet is loosely fitted on the rotary shaft and fixing of the rotor magnet is done by using adhesive. In this motor, adhesive needs not be filled in between the bottom of the permanent magnet and the inner bottom surface of the magnet holder. When this structure is applied to a motor-driven compressor, the lubricating oil flows to the bottom of the permanent magnet through spaces formed between the key of the magnet holder and the keyway of the rotor shaft and is attached to the bottom of the permanent magnet, with the result that free water produced from the lubricating oil may corrode the permanent magnet.

The present invention is directed to providing a motor-driven compressor that prevents the corrosion of a permanent magnet provided in an electric motor of the compressor.

### SUMMARY OF THE INVENTION

A compressor includes a housing, a compression mechanism and an electric motor driving the compression mechanism. The electric motor includes a stator fixed to the housing, a rotary shaft rotatably supported by the housing, a rotor that is fixed on the rotary shaft and has a rotor core made of a plurality of laminated steel sheets, a magnet insertion hole formed through the rotor core, a permanent magnet loosely fitted in the magnet insertion hole, a first clearance formed between inner surface of the magnet insertion hole and outer surface of the permanent magnet, a second clearance formed between end surface of the rotor core and surface of the permanent magnet in the axial direction of the rotor core and resin filled in the first clearance and the second clearance so as to surround entire surface of the permanent magnet.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal sectional view of a motor-driven scroll type compressor according to a first embodiment of the present invention;

FIG. 2 is a front view of a rotor core of the compressor of FIG. 1;

FIG. 3A is an enlarged front view of a magnet insertion hole and a permanent magnet of the compressor of FIG. 1, showing a state before resin is filled;

FIG. 3B is an enlarged front view similar to FIG. 3A, but showing a state after resin is filled;

FIG. 4 is a sectional view taken along the line A-A of FIG. 2;

FIG. 5 is a side view describing a manner of inserting the permanent magnet into the magnet insertion hole; and

FIG. 6 is a partially sectional side view describing a manner of filling resin.

### DETAILED DESCRIPTION OF THE PREFERRED EMBODIMENTS

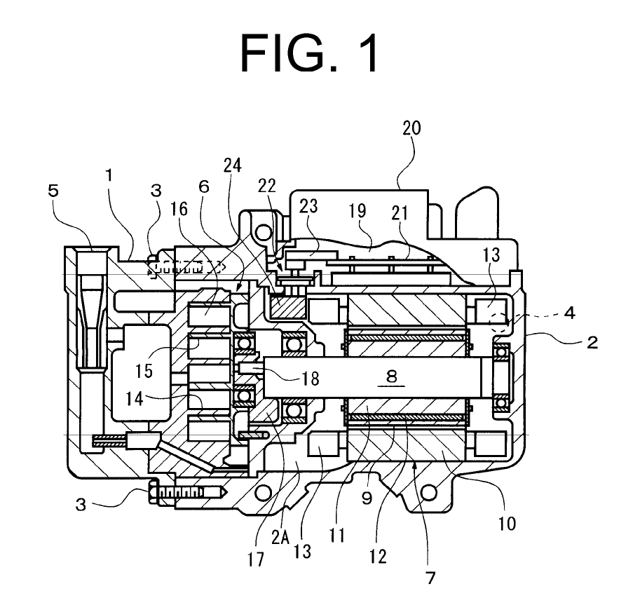

The following will describe the motor-driven scroll type compressor (hereinafter simply referred to as “compressor”) according to the first embodiment of the present invention with reference to FIGS. 1 through 6. The compressor includes a front housing 1 and a rear housing 2 that are fixedly connected to each other by bolts 3 thereby to form a sealed housing having therein an interior space 2A. The front and the rear housings 1, 2 are made of aluminum or an aluminum alloy and have formed therein an inlet 4 and an outlet 5, respectively that are connected to an external refrigerant circuit (not shown).

A compression mechanism 6 and an electric motor 7 that drives the compression mechanism 6 are disposed in the interior space 2A formed by the front and the rear housings 1, 2. The electric motor 7 includes a rotary shaft 8 that is rotatably supported by the rear housing 2, a rotor 9 that is fixed on the rotary shaft 8 and a stator 10 that is disposed outward of the rotor 9 and fixed to inner surface of the rear housing 2. The rotor 9 includes a rotor core 11 that is made of a plurality of laminated thin steel sheets and a plurality of permanent magnets 12. The stator 10 includes three-phase coils 13.

The compression mechanism 6 includes a fixed scroll 14 that is fixed to the inner walls of the front and the rear housings 1, 2 and a movable scroll 15 disposed in facing relation to the fixed scroll 14. The fixed scroll 14 and the movable scroll 15 cooperate to form a variable-volume compression chamber 16 for compressing refrigerant gas. The movable scroll 15 that is connected to an eccentric pin 18 of the rotary shaft 8 through a bearing and an eccentric bush 17 makes an orbital motion around the rotary shaft 8 in accordance with the rotation of the rotary shaft 8 while preventing the movable scroll 15 from rotating thereby to change the volume of the compression chamber 16.

An inverter housing 20 forming an inverter compartment 19 is joined and fixedly connected to the outer peripheral surface of the rear housing 2. An inverter 21 and an airtight terminal 22 are fixed to the outer peripheral surface of the rear housing 2 in the inverter compartment 19. The airtight terminal 22 is electrically connected to the inverter 21 through a connector 23 in the inverter compartment 19 and also to a lead wire (not shown) of the coil 13 of the stator 10 through a cluster block 24 in the interior space 2A of the rear housing 2. The rotor 9 is rotated by excitation of the coil 13 of the electric motor 7 by the inverter 21 through the airtight terminal 22, with the result that the rotary shaft 8 is rotated thereby to drive the compression mechanism 6.

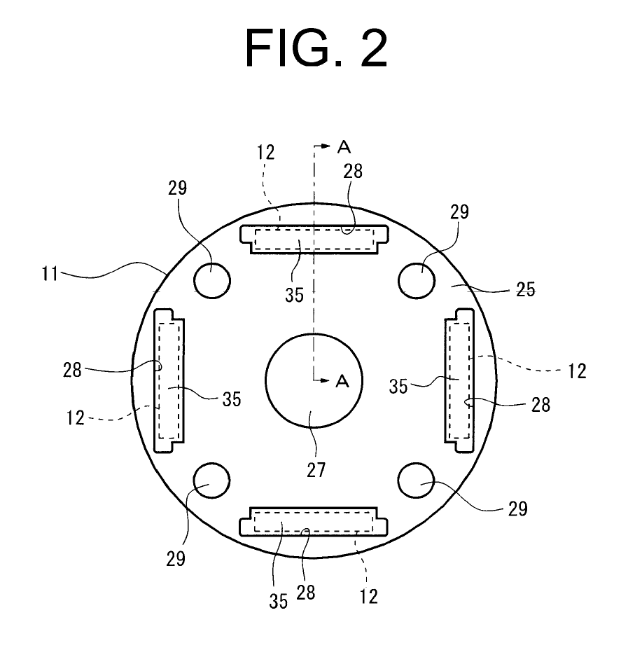

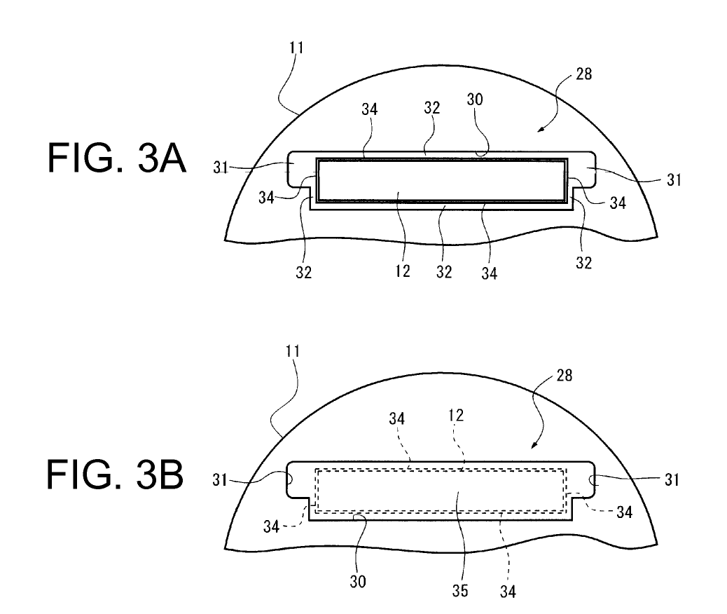

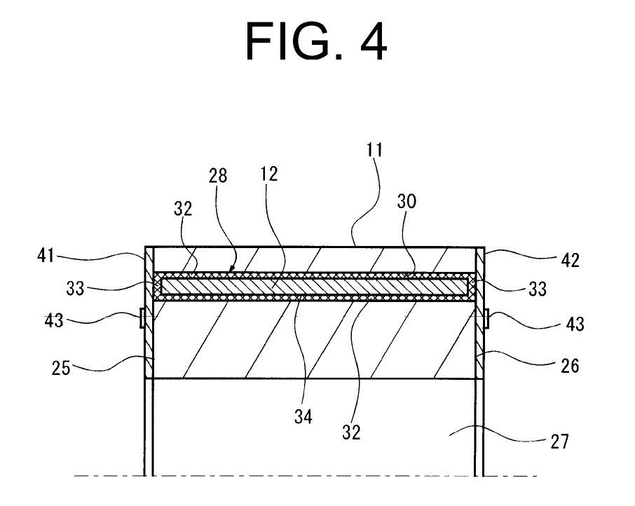

As shown in FIGS. 2 through 4, the rotor core 11 has formed therethrough from one end surface thereof to the other end surface a shaft hole 27 for the rotary shaft 8, four magnet insertion holes 28 in which permanent magnets 12 are loosely fitted and four rivet holes 29 for rivets. The rotary shaft 8 is press fitted in the shaft hole 27 that is formed in the center of the rotor core 11 and fixed to the rotor core 11 for rotation therewith. Each magnet insertion hole 28 includes a magnet insertion space 30 with a rectangular cross-section and extension spaces 31 that are formed on the opposite ends of the magnet insertion space 30 as viewed in the front view of the rotor core 11 for connection of the ends of the magnet insertion space 30 in the axial direction of the rotor core 11 for improving the function of the permanent magnet 12. As shown in FIG. 2, the magnet insertion holes 28 are formed at four positions that are spaced equiangularly around the shaft hole 27. The dimensions of the magnet insertion space 30 of the magnet insertion hole 28, including the length corresponding to the long side of the magnet insertion hole 28 as viewed in the front view of the rotor core 11, the width corresponding to the short side of the magnet insertion hole 28 as viewed in the front view of the rotor core 11 and the depth corresponding to the distance between opposite end surfaces of the magnet insertion space 30 in the axial direction of the rotor core 11, are set larger than those of the permanent magnet 12 so that the permanent magnet 12 may be loosely fitted in the magnet insertion hole 28. The permanent magnet 12 as loosely fitted in the magnet insertion hole 28 is entirely housed in the magnet insertion hole 28 without protruding outside the magnet insertion hole 28. A first clearance 32 is formed between inner surface of the magnet insertion space 30 and outer peripheral surface of the permanent magnet 12 (shown in FIG. 3A). Additionally, a second clearance 33 is formed between end surface of the rotor core 11 and end surface of the permanent magnet 12 in the axial direction of the rotor core 11, as shown in FIG. 4.

The permanent magnet 12 is made of a rare-earth magnet such as neodymium magnet or samarium-cobalt magnet and coated on the entire surface thereof with a coating layer 34 made of an inorganic material as a corrosion-resistance material such as nickel or aluminum. The permanent magnet 12 may be made of any other rare-earth magnet than the above neodymium magnet and the samarium-cobalt magnet. Additionally, the permanent magnet 12 is not limited to being made of a rare-earth magnet but may be made of an alloy magnet, a ferrite magnet or any suitable magnet. Examples of the alloy magnet include an alnico magnet (Al—Ni—Co) and a ferrum-chrome-cobalt magnet (Fe—Cr—Co).

After the permanent magnet 12 is inserted in the magnet insertion hole 28, resin 35 is filled in the first and the second clearances 32, 33 so as to surround the entire surface of the permanent magnet 12. A water-resistant material is used as the resin 35. Preferably, a thermo-setting resin such as silicon resin, polyurethane resin or epoxy resin or thermoplastic resin such as fluorine-contained resin may be used.

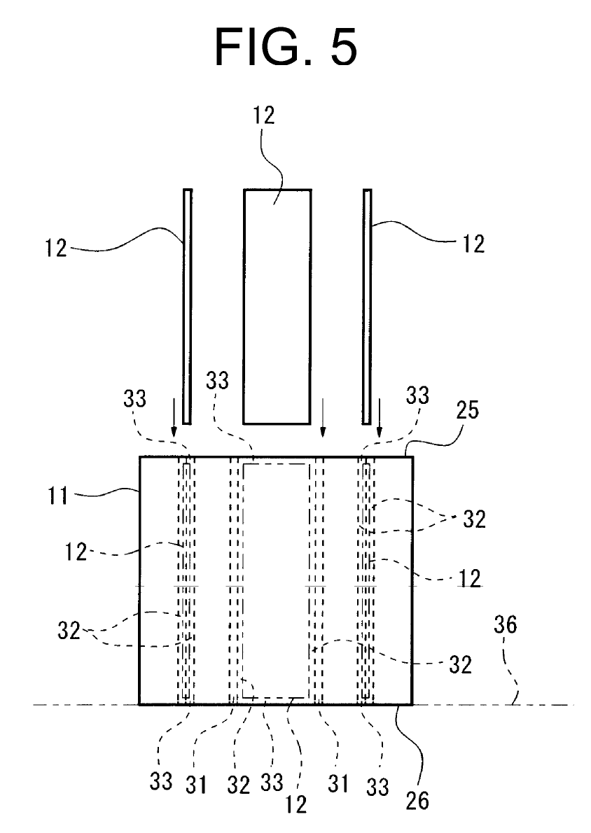

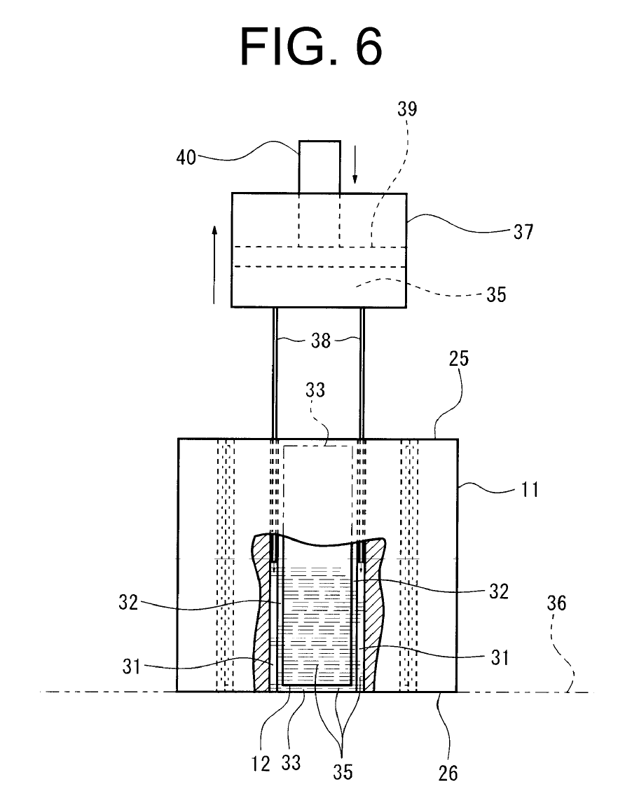

The following will describe a method for filling of the resin 35 with reference to FIGS. 5 and 6. The rotor core 11 is set on a work table 36 with the opposite end surfaces 25, 26 positioned at the top and the bottom, respectively, as shown in FIG. 5. Four permanent magnets 12 coated with the coating layer 34 are loosely fitted in the respective magnet insertion holes 28 formed through the rotor core 11 so that each permanent magnet 12 is entirely placed within the magnet insertion hole 28 without any part of the permanent magnet 12 lying outside the magnet insertion hole 28. The permanent magnet 12 can be held in the insertion space 30 by being attached magnetically against an inner wall surface of the insertion hole 28.

As shown in FIG. 6, a resin tank 37 storing resin 35 is vertically movably disposed above the end surface 25 of the rotor core 11 set on the work table 26. The resin tank 37 has two injectors 38 extending from the bottom of the tank 37 and facing the respective extension spaces 31 of the magnet insertion hole 28, respectively. The resin tank 37 further has therein a piston 39 joined to a piston rod 40 that is in turn connected to any suitable piston moving mechanism.

The resin tank 37 is moved downward so as to insert two injectors 38 into the respective extension spaces 31 of the magnet insertion hole 28. When the injectors 38 are moved to a position adjacent to the bottom end surface 26 of the rotor core 11, the resin tank 37 stops moving downward. Subsequently, the piston moving mechanism (not shown) is activated to apply pressure to resin 35 in the resin tank 37 by the piston 39 then moving downward and to fill the first and the second clearances 32, 33 and the extension spaces 31 of the magnet insertion hole 28 from the bottom end surface 26 side with resin 35 through the injectors 38. Moving the resin tank 37 upward gradually while allowing resin 35 to be injected from the injectors 38, the first and the second clearances 32, 33 and the extension spaces 31 of the magnet insertion hole 28 can be entirely filled with resin 35. The resin 35 can be hardened by heat treatment or cooling. Thus, the permanent magnet 12 is fixed in the magnet insertion hole 28, entirely surrounded by the resin 35.

After the permanent magnet 12 is fixed in the magnet insertion hole 28 of the rotor core 11, the rotor 9 is formed in such a way that the rotor core 11 is joined to end plates 41, 42 at the opposite end surfaces 25, 26 of the rotor core 11, respectively, and fixed to the end plates 41, 42 firmly by rivets 43 that are inserted through the rivet holes 29 and holes (not shown) formed through the end plates 41, 42 at positions corresponding to the rivet holes 29.

The compressor according to the first embodiment offers the following advantageous effects. In operation of the compressor, refrigerant gas introduced through the inlet 4 flows through the electric motor 7 and into the compression mechanism 6 to be compressed and the compressed refrigerant flows out through the outlet 5 into the external refrigerant circuit (not shown). The lubricating oil that is contained in refrigerant gas and flows therewith in the refrigerant circuit becomes high in temperature during the operation of the compressor, so that water present in the compressor is diffused in the lubricating oil and, therefore, trouble associated with corrosion of the permanent magnet rarely occurs.

When the compressor is at a stop, the amount of saturated water vapor decreases with a decrease in temperature of the lubricating oil, and therefore, a significant amount of free water is produced. Such free water resides in the compressor in various places including the surroundings of the rotor 9 of the electric motor 7. Lubricating oil in the rotor 9 permeates into the surroundings of the rotor core 11 and small clearances between the laminated magnetic steel sheets. However, the resin 35 fills the magnet insertion hole 28 in such a way as to surround the entire surface of the permanent magnet 12, so that the resin 35 can prevent free water from permeating to the permanent magnet 12. Therefore, the permanent magnet 12 that is free from contact with free water produced in the compressor is prevented from being corroded, with the result that the performance of the electric motor 7 and the stable operation of the compressor are ensured.

The permanent magnet 12 is covered with the coating layer 34 that prevents the permanent magnet 12 from being corroded even when any part of the surroundings of the permanent magnet 12 is not filled with the resin 35 and free water permeates through such part. Thus, the permanent magnet 12 is protected from free water and hence from corrosion by such double water-resistant structure.

The present invention is not limited to the compressor according to the first embodiment but may be variously modified within the scope of the invention, as exemplified below.
(1) In the compressor according to the first embodiment, the permanent magnet 12 that is covered with the coating layer 34 having a water-resistant property is inserted into the magnet insertion hole 28 and furthermore covered completely with resin 35 that fills magnet insertion hole 28 so as to surround the permanent magnet 12. However, the permanent magnet 12 may dispense with the coating layer 34, but may be covered with only resin 35 against the corrosion.
(2) In the compressor according to the first embodiment, the extension spaces 31 are formed to be continuous with the magnet insertion space 30 and resin 35 is injected into the extension spaces 31. However, the extension spaces 31 may be formed so as to be separated from the magnet insertion space 30. In this case, resin 35 is directly injected into the first and the second clearances 32, 33 forming the magnet insertion hole 28 so as to fill the magnet insertion hole 28 with the resin 35.
(3) In the compressor according to the first embodiment, the electric motor 7 is disposed in the compressor at a position adjacent to the inlet 4 that is subjected to a suction pressure of refrigerant gas. However, the electric motor 7 may be disposed at a position adjacent to the outlet 5 that is subjected to a discharge pressure of refrigerant gas.
(4) In the present invention, the magnet insertion hole 28 is filled with the resin 35 in such a way as to cover the entire surface of the permanent magnet 12, so that the permanent magnet 12 is prevented from being slipped out of the magnet insertion hole 28. Therefore, the rotor 9 may dispense with the end plates 41, 42 that are joined and fixed to the opposite ends of the rotor core 11.
(5) The compressor is not limited to a motor-driven scroll-type compressor as in the embodiment of the present invention, as shown in FIG. 1, but may be applied to a motor-driven rotary-type compressor such as a vane type compressor or a screw-type compressor, or a motor-driven reciprocating compressor such as a swash-type compressor or a wobble-type compressor.

What is claimed is:

1. A motor-driven compressor comprising:
a housing;
a compression mechanism housed in the housing; and
an electric motor driving the compression mechanism, wherein the electric motor including;
a stator fixed to the housing;
a rotary shaft rotatably supported by the housing;
a rotor that is fixed on the rotary shaft and has a rotor core made of a plurality of laminated steel sheets;
a magnet insertion hole formed through the rotor core;
a permanent magnet loosely fitted in the magnet insertion hole:
a first clearance formed between inner surface of the magnet insertion hole and outer surface of the permanent magnet;
a second clearance formed between end surface of the rotor core and surface of the permanent magnet in the axial direction of the rotor core; and
resin filled in the first clearance and the second clearance so as to surround entire surface of the permanent magnet.

2. The motor-driven compressor according to claim 1, wherein the permanent magnet further includes a coating layer that is made of a corrosion-resistance material and coating the entire surface of the permanent magnet.

3. The motor-driven compressor according to claim 1, wherein the resin is made of water-resistant thermo-setting resin or water-resistant thermoplastic resin.

4. The motor-driven compressor according to claim 1, wherein the magnet insertion hole further including:
a magnet insertion space formed through the rotor core and having a rectangular cross-section; and
extension spaces formed on opposite ends of the magnet insertion space as viewed in the front view of the rotor core for connection of ends of the magnet insertion space in the axial direction of the rotor core.

5. The motor-driven compressor according to claim 4, wherein length corresponding to a long side of the magnet insertion hole as viewed in the front view of the rotor core, width corresponding to a short side of the magnet insertion hole as viewed in the front view of the rotor core and depth corresponding to a distance between opposite end surfaces of the magnet insertion space in the axial direction of the rotor core are set larger than those of the permanent magnet so that the permanent magnet is entirely housed in the magnet insertion hole.
